(19) United States
(12) Patent Application Publication
(10) Pub. No.: US 2014/0208049 A1
(43) Pub. Date: Jul. 24, 2014

(54) APPARATUS AND METHOD FOR MIGRATING VIRTUAL MACHINES

(71) Applicant: Fujitsu Limited, Kawasaki-shi (JP)

(72) Inventors: Kei FURUSAWA, Kawasaki (JP); Tatsuhiro Ando, Kawasaki (JP)

(73) Assignee: Fujitsu Limited, Kawasaki-shi (JP)

(21) Appl. No.: 14/064,720

(22) Filed: Oct. 28, 2013

(30) Foreign Application Priority Data
Jan. 22, 2013 (JP) 2013-009619

(51) Int. Cl. G06F 3/06

(52) U.S. Cl. CPC G06F 3/0647; G06F 3/0619; G06F 3/067
USPC 711/162

(57) ABSTRACT

A first apparatus runs a first virtual machine. The first apparatus receives first migration information including a first migration instruction regarding the first virtual machine and a second migration instruction regarding a second virtual machine. The first apparatus receives data for the first virtual machine, and transfers second migration information including the second migration instruction to a second apparatus running the second virtual machine.

### CROSS-REFERENCE TO RELATED APPLICATION

This application is based upon and claims the benefit of priority of the prior Japanese Patent Application No. 2013-009619, filed on Jan. 22, 2013, the entire contents of which are incorporated herein by reference.

### FIELD

The present technology discussed herein is related to apparatus and method for migrating virtual machines.

### BACKGROUND

Cloud enterprises related to Infrastructure as a Service (IaaS), for example, provide server resources to users over the Internet by using server virtualization technology that allows virtual machines to operate on physical servers.

Cloud enterprises sometimes migrate virtual machines which are currently operating between physical servers to effectively utilize existing resources, for example. A live migration is performed to migrate these virtual machines so that no services provided by the virtual machines are stopped. It is also desirable for the process of live migrations to be performed quickly when cloud enterprises which manage many virtual machines perform multiple migrations.

Japanese Laid-open Patent Publication No. 2012-88808 discloses a method to process multiple live migrations in parallel. This parallel execution of live migrations involves a simultaneous starting of a live migration for a virtual machine and a live migration of another virtual machine.

Japanese Laid-open Patent Publication No. 2011-232916 discloses a method to process multiple live migrations in serial. This serial execution of live migrations involves a starting of a live migration for a next virtual machine after a live migration for a virtual machine is complete.

In either case of executing multiple live migrations, these live migrations are not necessarily related to the same physical server. For this reason, the processing load on the physical server managing multiple live migrations is significant.

### SUMMARY

According to an aspect of the invention, an apparatus receives first migration information including a first migration instruction regarding a first virtual machine and a second migration instruction regarding a second virtual machine. The apparatus receives data for the first virtual machine, and transfers second migration information including the second migration instruction to another apparatus running the second virtual machine.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a network on which a virtual machine migration system is operated, according to an embodiment;

FIG. 2 is a diagram illustrating a configuration example of a physical server including a virtual machine, according to an embodiment;

FIG. 3 is a diagram illustrating a configuration example of an operations administration network, according to an embodiment;

FIG. 4 is a diagram illustrating a configuration example of a physical server including an administration unit, according to an embodiment;

FIG. 5 is a diagram illustrating an example of an operational sequence for a virtual machine migration system, according to an embodiment;

FIG. 6 is a diagram illustrating an example of a migration table, according to an embodiment;

FIG. 7 is a diagram illustrating an example of a migration table, according to an embodiment;

FIG. 8 is a diagram illustrating a configuration example of an ARP packet, according to an embodiment;

FIG. 9 is a diagram illustrating a configuration example of a data portion, according to an embodiment;

FIG. 10 is a diagram illustrating an example of an operational sequence continuing from that in FIG. 5, according to an embodiment;

FIG. 11 is a diagram illustrating an example of a migration table, according to an embodiment;

FIG. 12 is a diagram illustrating a configuration example of an administration unit, according to an embodiment;

FIG. 13 is a diagram illustrating an example of an operational flowchart for an administration unit, according to an embodiment;

FIG. 14 is a diagram illustrating a configuration example of a physical server including a virtual machine, according to an embodiment;

FIG. 15 is a diagram illustrating an example of an operational flowchart for a hypervisor including a virtual machine, according to an embodiment;

FIG. 16 is a diagram illustrating an example of an operational flowchart for a sending process, according to an embodiment;

FIG. 17 is a diagram illustrating an example of an operational flowchart for a receiving process, according to an embodiment;

FIG. 18 is a diagram illustrating an example of an operational flowchart for a hypervisor including a virtual machine, according to an embodiment;

FIG. 19 is a diagram illustrating an example of an operational flowchart for an analysis process, according to an embodiment;

FIG. 20 is a diagram illustrating a transition example of a migration table, according to an embodiment;

FIG. 21 is a diagram illustrating a transition example of a migration table, according to an embodiment;

FIG. 22 is a diagram illustrating an example of an operational sequence when an error has occurred, according to an embodiment;

FIG. 23 is a diagram illustrating an example of an operational flowchart for a hypervisor including a virtual machine, according to an embodiment;

FIG. 24 is a diagram illustrating an example of an operational flowchart for a recovery process, according to an embodiment; and

FIG. 25 is a diagram illustrating an example of a configuration of a computer, according to an embodiment.

### DESCRIPTION OF EMBODIMENTS

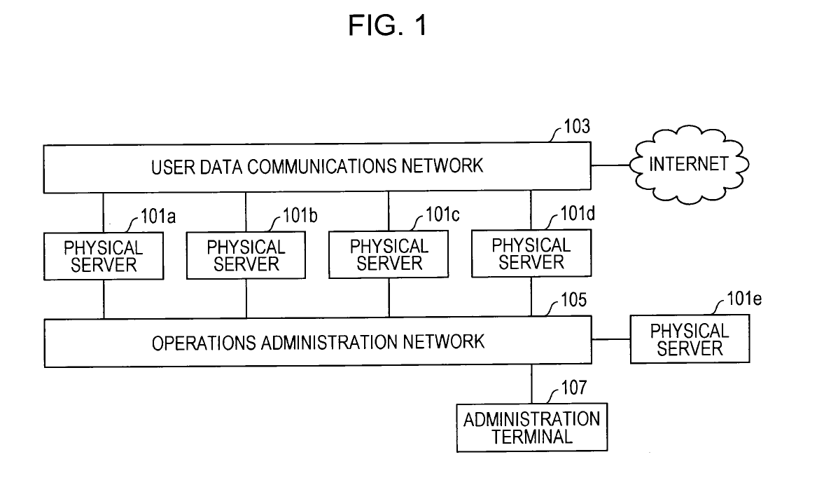

FIG. 1 is a diagram illustrating an example of a network on which a virtual machine migration system is operated, according to an embodiment. Physical servers 101a through 101d are examples of a physical server 101 including virtual machines. The physical servers 101a through 101d are coupled to a user data communications network 103. The user data communications network 103 is also coupled to the Internet. The user data communications network 103 is used for communications between the physical servers 101a through 101d as well as communications between the Internet and the physical servers 101a through 101d.

The physical servers 101a through 101d are coupled via an operations administration network 105. A physical server 101e and an administration terminal 107 are also coupled to the operations administration network 105. The administration terminal 107 is a terminal used by the administrator. The physical server 101e includes an administration unit for managing the physical servers 101a through 101d. The administrator uses the administration unit by operating the administration terminal 107.

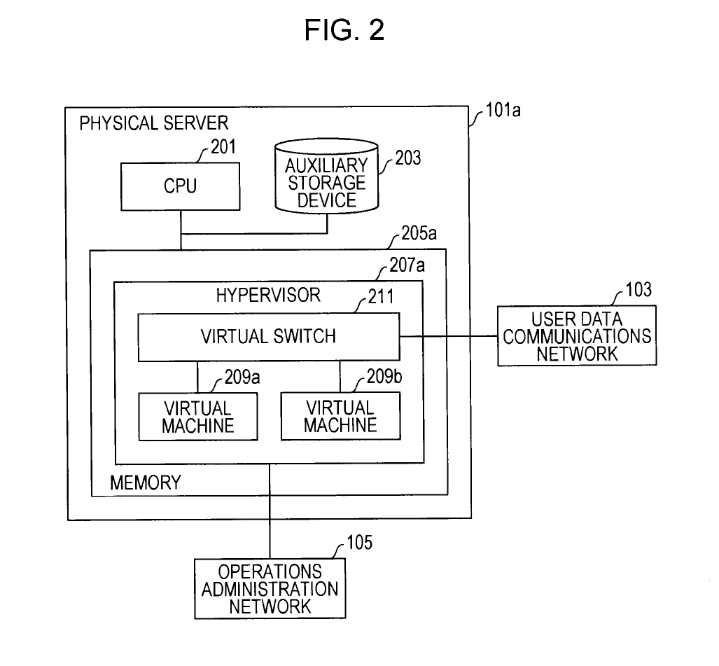

FIG. 2 is a diagram illustrating a configuration example of a physical server including a virtual machine, according to an embodiment. In the example of FIG. 2, a physical server 101 includes a virtual machine 209. Since configurations of the physical servers 101a through 101d are similar, the description will focus on the configuration of the physical server 101a. The physical server 101a includes a central processing unit (CPU) 201, an auxiliary storage device 203, and a memory 205a.

The CPU 201 performs arithmetic processing. The auxiliary storage device 203 stores data. A hypervisor 207a resides in the memory 205a. The memory 205a is an example of a memory 205, and the hypervisor 207a is an example of a hypervisor 207. The hypervisor 207a includes a virtual switch 211 and a virtual machine 209. The virtual switch 211 is coupled to the user data communications network 103. A virtual machine 209a and a virtual machine 209b are examples of the virtual machine 209. One or more virtual machines 209 are held by the hypervisor 207. There are also cases when the virtual machines 209 are not held by the hypervisor 207. The virtual machine 209a and the virtual machine 209b are coupled to the Internet via the user data communications network 103. The user accesses the virtual machine 209 from the user terminal through the Internet. The hypervisor 207a is coupled to the operations administration network 105.

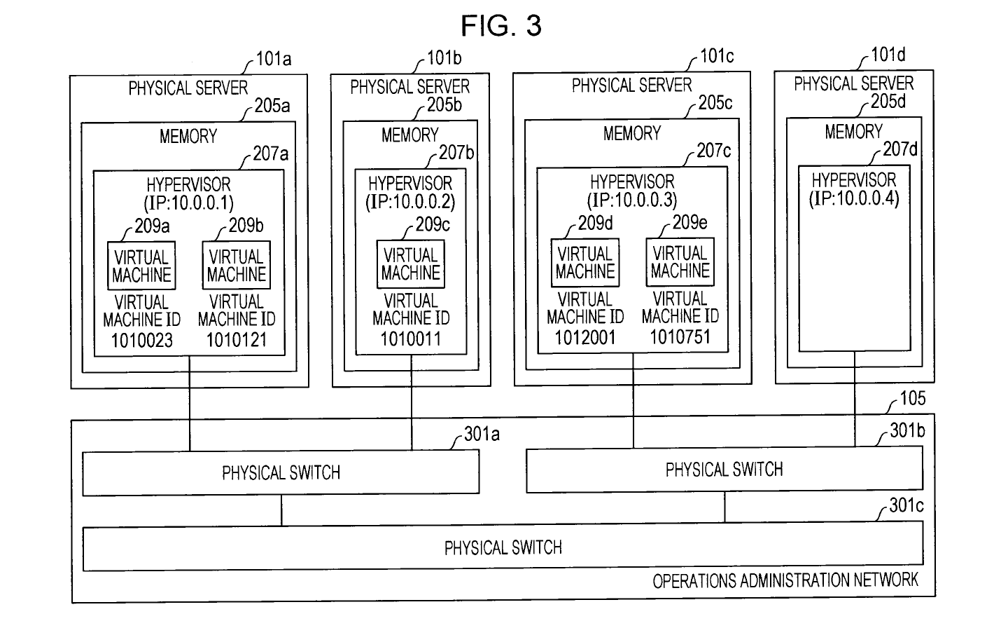

FIG. 3 is a diagram illustrating a configuration example of an operations administration network, according to an embodiment. The operations administration network 105 in this example includes a layered physical switch 301. The operations administration network 105 in this example includes lower layer physical switches 301a and 301b, and an upper layer physical switch 301c. The hypervisor 207a for the physical server 101a and the hypervisor 207b for the physical server 101b are coupled to the lower layer switch 301a. The hypervisor 207c for the physical server 101c and the hypervisor 207d for the physical server 101d are coupled to the lower layer physical switch 301b.

As above described, the hypervisor 207a resides in the memory 205a in the physical server 101a. Similarly, the hypervisor 207b resides in a memory 205b in the physical server 101b. Similarly, the hypervisor 207c resides in the memory 205c in the physical server 101d. Similarly, the hypervisor 207d resides in the memory 205d in the physical server 101d. The hypervisor 207a also includes the virtual machine 209a and the virtual machine 209b. The hypervisor 207b includes the virtual machine 209c. The hypervisor 207c includes a virtual machine 209d and a virtual machine 209e. The hypervisor 207d does not include any virtual machines 209.

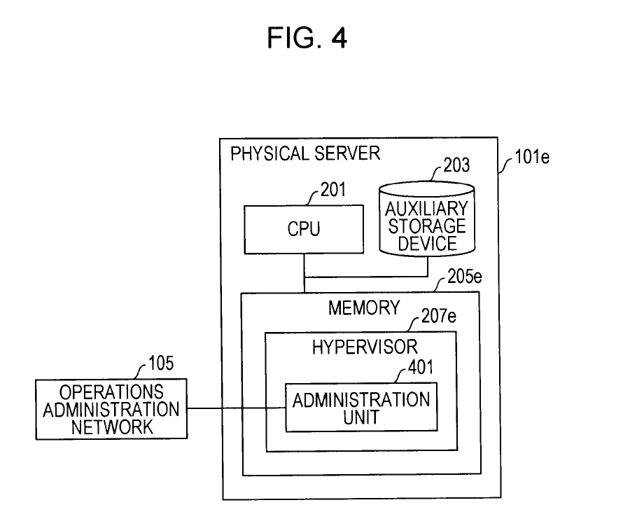

The configuration of the physical server including an administration unit 401 will be described. FIG. 4 is a diagram illustrating a configuration example of a physical server including an administration unit, according to an embodiment. In the example of FIG. 4, the physical server 101e includes the CPU 201, the auxiliary storage device 203, and a memory 205e. The CPU 201 performs arithmetic processing. The auxiliary storage device 203 stores data. A hypervisor 207e resides in the memory 205e. The hypervisor 207e includes an administration unit 401. The administration unit 401 is coupled to the operations administration network 105. That is to say, the administration unit 401 and the hypervisors 207a through 207d illustrated in FIG. 3 are coupled via the operations administration network 105.

The operations administration network 105 is used for control communications between the administration unit 401 and the hypervisors 207, and for data transfers regarding the live migrations of the virtual machines 209. The user data communications network 103 is used for communications between the virtual machines 209 and the users on the Internet, and for communications between the virtual machines 209.

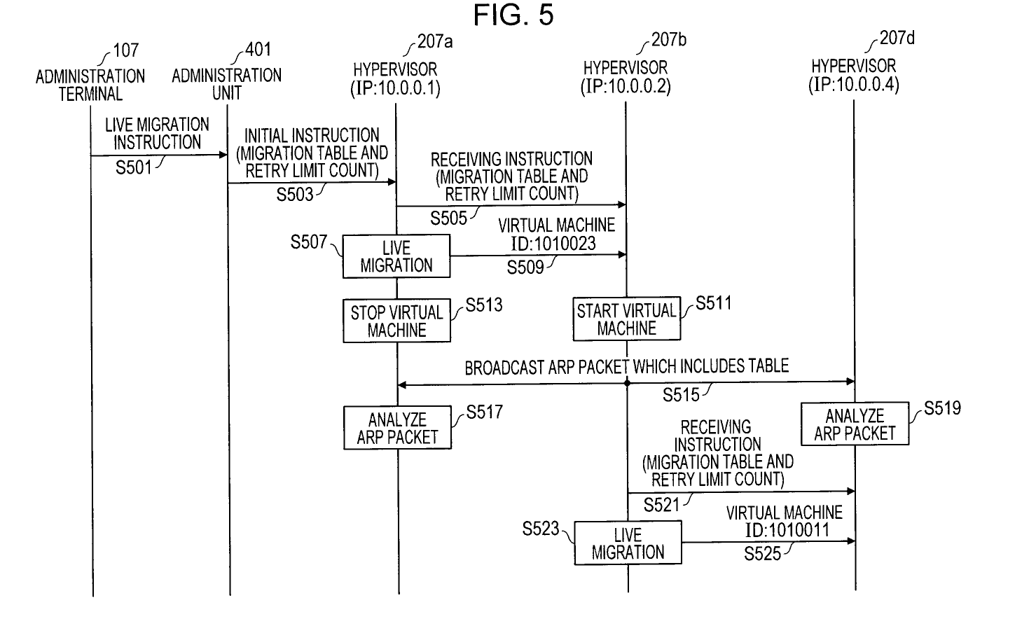

Next, an example sequence will be described. FIG. 5 is a diagram illustrating an example of an operational sequence for a virtual machine migration system, according to an embodiment. Note that the hypervisor 207c is omitted from the example of an operational sequence since the hypervisor 207c functions neither as the sender nor as the receiver for this case. The administration unit 401 receives a live migration instruction from the administration terminal 107 (S501). The live migration instruction includes a migration table and a retry limit count. The retry limit count is the number of retries that may be attempted after an error occurs during the live migration.

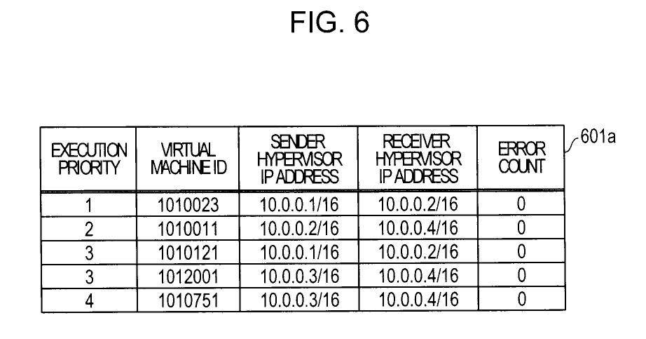

FIG. 6 is a diagram illustrating an example of a migration table, according to an embodiment. The example of FIG. 6 illustrates a migration table 601a at the initial stage. The migration table 601a includes a record for each live migration instruction. The record includes the fields for the execution priority, the virtual machine ID, the sender hypervisor Internet Protocol (IP) address, the receiver hypervisor IP address, and the error count. The execution priority represents the order in which the live migration is performed. The virtual machine ID is identification information for identifying the virtual machine 209 to be migrated during the live migration. The sender hypervisor IP address is the IP address of the sender hypervisor 207 which is the migration source of the virtual machine 209. The receiver hypervisor IP address is the IP address of the receiver hypervisor 207 which is the migration destination of the virtual machine 209. In this example, both the sender hypervisor IP address and the receiver hypervisor IP address have 16-bit subnet masks (/16). The error count is the number of errors that have occurred during the live migration of the relevant virtual machine 209.

The first record of the migration table 601a represents a live migration instruction in which the virtual machine 209a with a virtual machine ID of “1010023” is migrated from the hypervisor 207a with an IP address of “10.0.0.1/16” to the hypervisor 207b with an IP address of “10.0.0.2/16”. This record also indicates that the execution priority is one. According to this example, a smaller execution priority number indicates that the instruction is executed earlier.

The second record of the migration table 601a represents a live migration instruction in which the virtual machine 209c with a virtual machine ID of “1010011” is migrated from the hypervisor 207b with an IP address of “10.0.0.2/16” to the hypervisor 207d with an IP address of “10.0.0.4/16”. This record also indicates that the execution priority is two.

The third record of the migration table 601a represents a live migration instruction in which the virtual machine 209b with a virtual machine ID of “1010121” is migrated from the hypervisor 207a with an IP address of “10.0.0.1/16” to the hypervisor 207b with an IP address of “10.0.0.2/16”. This record also indicates that the execution priority is three.

The fourth record of the migration table 601a represents a live migration instruction in which the virtual machine 209d with a virtual machine ID of “1012001” is migrated from the hypervisor 207c with an IP address of “10.0.0.3/16” to the hypervisor 207d with an IP address of “10.0.0.4/16”. This record also indicates that the execution priority is three.

According to this example, the live migration instruction represented by the third record and the live instruction represented by the fourth record of the migration table 601a have the same execution priority, which indicates that these instructions are executed in parallel.

The fifth record of the migration table 601a represents a live migration instruction in which the virtual machine 209e with a virtual machine ID of “1010751” is migrated from the hypervisor 207c with an IP address of “10.0.0.3/16” to the hypervisor 207d with an IP address of “10.0.0.4/16”. This record also indicates that the execution priority is four.

The error count for all of the records in the migration table 601a is zero since the system is at the initial stage and no live migrations have been executed yet.

Returning to the sequence illustrated in FIG. 5, the administration unit 401 identifies a hypervisor 207a that is registered in the first record having an execution priority of one, and then the administration unit 401 sends the initial instruction to the hypervisor 207a (S503). The initial instruction includes the migration table 601a and the retry limit count. The hypervisor 207a which has received the initial instruction temporarily stores the received migration table 601a.

The hypervisor 207a identifies the hypervisor 207b that is registered as a receiver hypervisor in the first record having an execution priority of one, and then the hypervisor 207a sends a receiving instruction to the hypervisor 207b (S505). The receiving instruction includes the migration table 601a and the retry limit count. The hypervisor 207b which has received the receiving instruction temporarily stores the received migration table 601a.

The hypervisor 207a performs the live migration (S507). Specifically, the hypervisor 207a sends data of the virtual machine 209a (virtual machine ID: 1010023) to the hypervisor 207b (S509).

The hypervisor 207b which has received data of the virtual machine 209a (virtual machine ID: 1010023) stores the data for the virtual machine 209a in a predetermined region, and starts the relevant virtual machine 209a (S511). Conversely, the hypervisor 207a stops the virtual machine 209a which has just been sent (S513). For example, the virtual machine 209a is stopped after the hypervisor 207a receives a live migration completion notification from the receiver hypervisor 207b. An arrangement may be made wherein end of the live migration is determined regardless of the live migration completion notification. In the operational sequence illustrated in FIG. 5, the live migration completion notification is omitted. The hypervisor 207a discards the stored migration table 601a.

The hypervisor 207b updates the migration table 601a. For example, the hypervisor 207b deletes the first record related to the live migration which has already been executed.

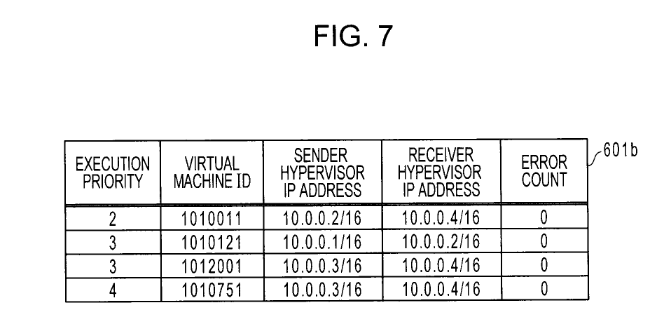

FIG. 7 is a diagram illustrating an example of a migration table, according to an embodiment. The example of FIG. 7 represents a migration table 601b being at the next stage after the completion of the first live migration. The first record in the migration table 601a at the initial stage is removed from this table. The second through fifth records in the migration table 601a at the initial stage are moved up in order to become the first through fourth records in the migration table 601b.

Returning to the operational sequence in FIG. 5, the hypervisor 207b generates an ARP packet which contains the migration table 601b, and broadcasts the generated ARP packet (S515). The ARP packet is sent over the user data communications network 103.

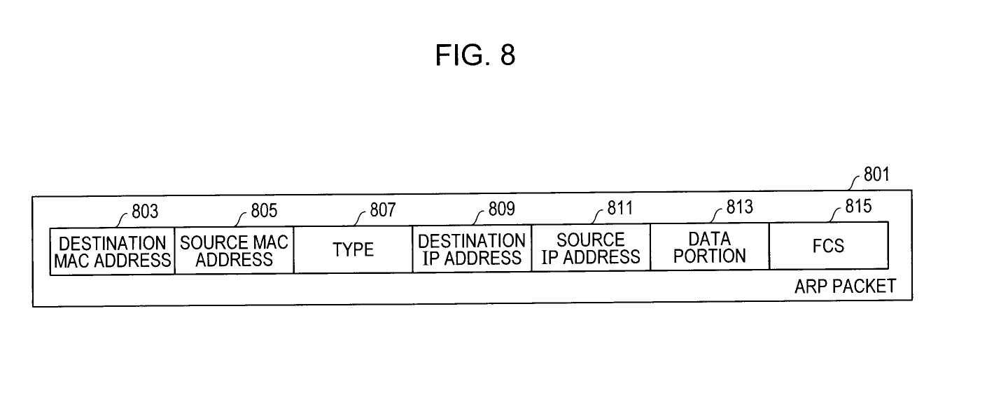

FIG. 8 is a diagram illustrating a configuration example of an ARP packet, according to an embodiment. The ARP packet is used to dynamically identify media access control (MAC) addresses corresponding to a given IP address. According to a certain embodiment, a portion of the ARP packet is used to transfer data for controlling the virtual machine migration.

An ARP packet 801 includes a destination MAC address 803, a source MAC address 805, a type 807, a destination IP address 809, a source IP address 811, a data portion 813, and a frame check sequence (FCS) 815.

The destination MAC address 803 is the MAC address for the destination of the virtual machine migration. The source MAC address 805 is the MAC address for the source of the virtual machine migration. The type 807 is a previously set value representing that this packet is an ARP packet. The destination IP address 809 is the IP address for the destination of the virtual machine migration. The source IP address 811 is the IP address for the source of the virtual machine migration. The data portion 813 may store optional data. The FCS 815 is additional data used for error detection.

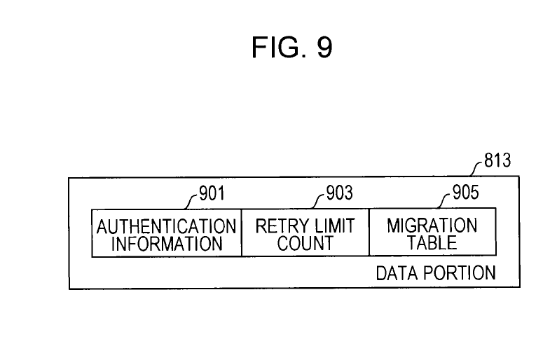

According to a certain embodiment, data for controlling the virtual machine migration is written into the data portion 813. FIG. 9 is a diagram illustrating a configuration example of a data portion, according to an embodiment. In FIG. 9, the data portion 813 includes authentication information 901, a retry limit count 903, and a migration table 905. The authentication information 901 is used to authenticate that the ARP packet regarding the virtual machine migration is authorized. As previously described, the retry limit count 903 is the number of retries that may be attempted when an error occurs during the live migration. The migration table 905 is the migration table 601 to be stored by the hypervisor 207.

Returning to the operational sequence in FIG. 5, the hypervisor 207a which has received the ARP packet analyzes the ARP packet (S517). The hypervisor 207a identifies a live migration to be executed. For example, the hypervisor 207a identifies a record with the smallest execution priority (the first record in the migration table 601b illustrated in FIG. 7). Then, the hypervisor 207a determines whether or not the hypervisor 207a is a sender hypervisor 207 on the basis of the virtual machine ID included in the record. Since the hypervisor 207a is not the sender hypervisor 207 at this stage, the hypervisor 207a executes no processing.

The hypervisor 207d which also has received the ARP packet analyzes the ARP packet (S519). Since the hypervisor 207d is also not a sender hypervisor 207, the hypervisor 207d similarly executes no processing.

The hypervisor 207b determines that the hypervisor 207b is a sender hypervisor 207 because the hypervisor 207b is running a virtual machine identified by the virtual machine ID of 1010011 included in the record with the smallest execution priority (the first record in the migration table 601b illustrated in FIG. 7). Then, the hypervisor 207b sends a receiving instruction to the hypervisor 207d serving as the destination of the virtual machine migration (S521). The receiving instruction includes the migration table 601 and the retry limit count. The hypervisor 207 may also determine that the hypervisor 207 is a sender hypervisor 207 on the basis of the sender hypervisor IP address.

The hypervisor 207b performs a live migration in the same way as previously described (S523). For example, the hypervisor 207b sends data of the virtual machine 209c (virtual machine ID: 1010011) to the hypervisor 207d (S525).

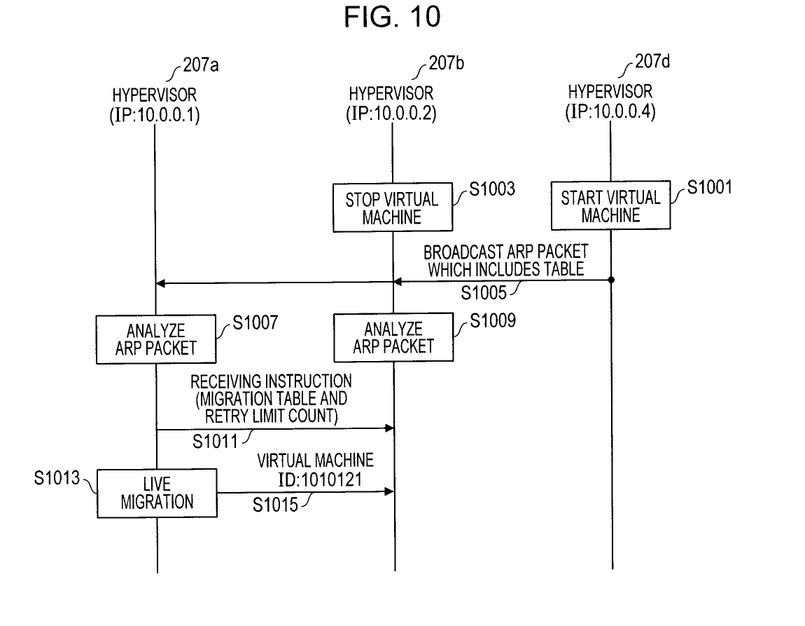

FIG. 10 is a diagram illustrating an example of an operational sequence continuing from that in FIG. 5, according to an embodiment. The hypervisor 207d which has received data for the virtual machine 209c (virtual machine ID: 1010011) stores the data of the virtual machine 209c in a predetermined region, and starts the virtual machine 209c (S1001). Conversely, the hypervisor 207b stops the virtual machine 209c just sent (S1003). The hypervisor 207b discards the stored migration table 601b.

The hypervisor 207d updates the migration table 601b. For example, the hypervisor 207d deletes the first record regarding the live migration which has already been executed.

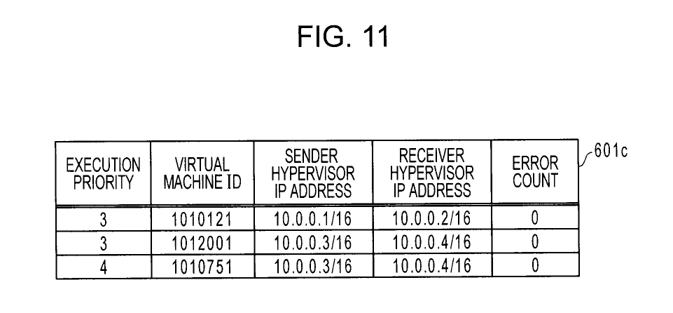

FIG. 11 is as diagram illustrating an example of a migration table, according to an embodiment. FIG. 11 illustrates a migration table 601c at the stage after the completion of the second live migration. The first record in the migration table 601b at the stage after the completion of the first live migration is removed from this table. The second through fourth records in the migration table 601b at the stage in which the second migration was completed are moved up in order to become the first through third records in the migration table 601c.

Returning to the sequence in FIG. 10, the hypervisor 207d generates an ARP packet which contains the migration table 601c, and broadcasts the generated ARP packet (S1005).

The hypervisor 207a which has received the ARP packet analyzes the ARP packet as previously described (S1007). The hypervisor 207a identifies a live migration to be executed. For example, the hypervisor 207a identifies a record with the smallest execution priority (the first record and the second record in the migration table 601c illustrated in FIG. 11). Then, the hypervisor 207a determines whether or not the hypervisor 207a is a sender hypervisor 207 on the basis of the virtual machine ID included in the record. Since the hypervisor 207a is a sender hypervisor 207 at this stage, and the hypervisor 207a stores the migration table 601c and sends a receiving instruction to the receiver hypervisor 207b which is the destination of the virtual machine migration (S1011).

The hypervisor 207a performs the live migration in the same way as previously described (S1013). For example, the hypervisor 207a sends data of the virtual machine 209b (virtual machine ID: 1010121) to the hypervisor 207b (S1015).

Upon receiving the ARP packet, the hypervisor 207b also analyzes the ARP packet (S1009). Since the hypervisor 207b is also not a sender hypervisor 207, the hypervisor 207b executes no processing.

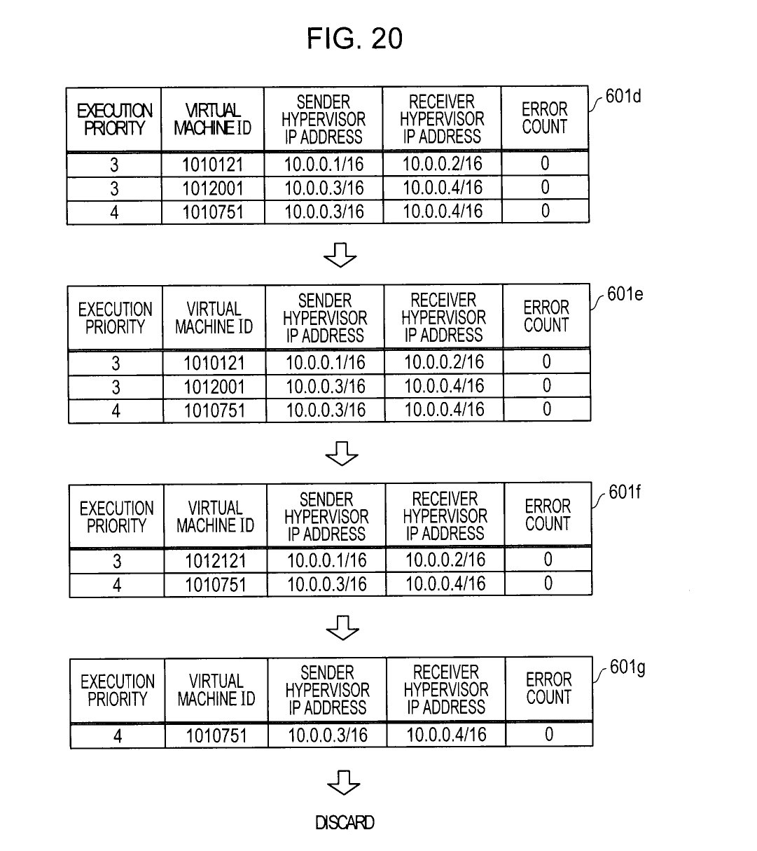

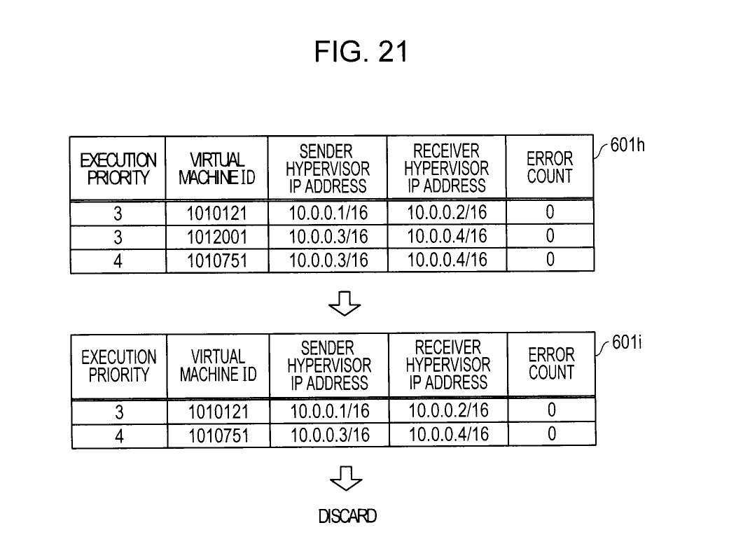

Since the hypervisor 207d is also a receiver hypervisor 207, the hypervisor 207d performs a live migration in parallel. Details on the operation of parallel live migrations will be described later with reference to FIGS. 20 and 21. This concludes the description of the operational sequence.

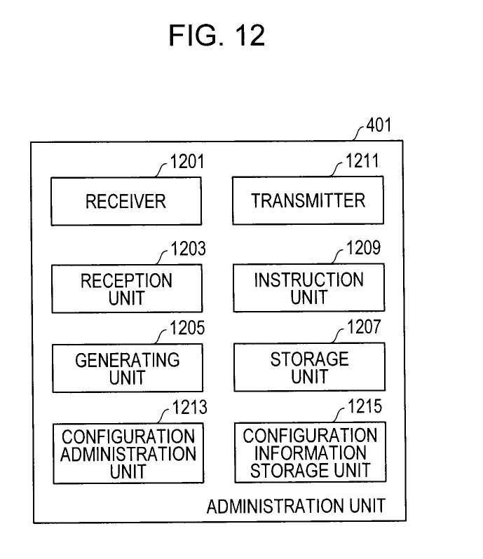

Next, a configuration of the administration unit 401 and processing performed by the administration unit 401 will be described. FIG. 12 is a diagram illustrating a configuration example of an administration unit, according to an embodiment. In FIG. 12, the administration unit 401 includes a receiver 1201, a reception unit 1203, a generating unit 1205, a storage unit 1207, an instruction unit 1209, a transmitter 1211, a configuration administration unit 1213, and a configuration information storage unit 1215.

The receiver 1201 receives data via the operations administration network 105. The reception unit 1203 receives instructions from the management terminal 107. The generating unit 1205 generates a migration table 601. The storage unit 1207 stores the migration table 601. The instruction unit 1209 gives instructions to the hypervisor 207. The transmitter 1211 sends data via the operations administration network 105. The configuration administration unit 1213 manages information related to configurations such as the CPU, memory, and network interfaces of the physical server 101, and statistical information such as CPU load, memory usage status, and network usage status. The configuration information storage unit 1215 stores the information related to configurations such as the CPU, memory, and network interfaces, and the statistical information such as CPU load, memory usage status, and network usage status.

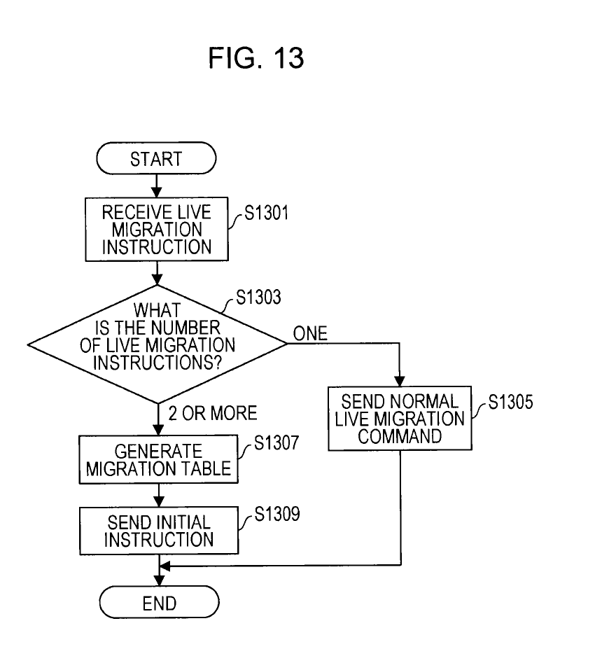

FIG. 13 is a diagram illustrating an example of an operational flowchart for an administration unit, according to an embodiment. The reception unit 1203 receives a live migration instruction from the management terminal 107 via the receiver 1201 (S1301). The live migration instruction includes the virtual machine ID of the virtual machine 209 to be migrated, the sender hypervisor IP address, and the receiver hypervisor IP address. The live migration instruction also includes the execution priority. The reception unit 1203 receives one or more live migration instructions. The administration unit 401 determines whether or not the number of live migration instructions is singular, or two or more (S1303).

The transmitter 1211 sends a normal live migration command to the sender hypervisor 207 when the number of live migration instructions is determined to be singular (S1305). The processing executed in response to the normal live migration command corresponds to that of the related art, and the description thereof is omitted.

The generating unit 1205 generates, for example, a migration table 601a for the initial stage illustrated in FIG. 6 when the number of live migration instructions is determined to be two or more (S1307). The migration table 601a is stored in the storage unit 1207.

The transmitter 1211 sends an initial instruction to the sender hypervisor 207 which is the source for the first live migration (S1309). The initial instruction includes the migration table 601 for the initial stage and the retry limit count.

The processing of the configuration administration unit 1213 which uses the configuration information storage unit 1215 corresponds to that of the related art, and the description thereof is omitted.

Next, the configuration of the physical server 101 including the virtual machine 209 and the processing of the hypervisor 207 including the virtual machine 209 will be described.

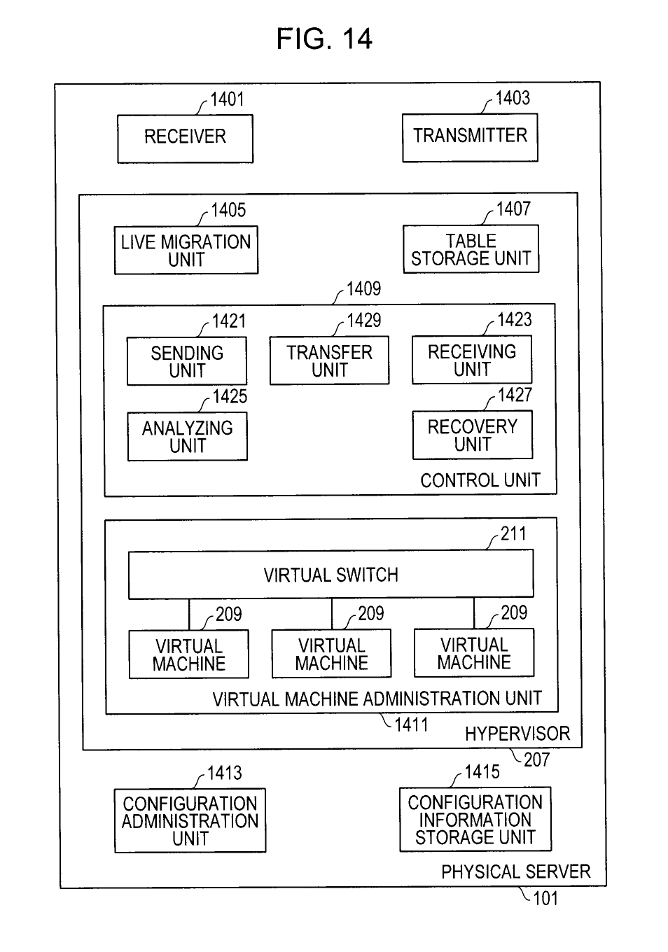

FIG. 14 is a diagram illustrating a configuration example of a physical server including a virtual machine, according to an embodiment, where the physical server 101 includes the virtual machine 209. The physical server 101 includes a receiver 1401, a transmitter 1403, a live migration unit 1405, a table storage unit 1407, a control unit 1409, a virtual machine administration unit 1411, a configuration administration unit 1413, and a configuration information storage unit 1415.

The receiver 1401 receives data via the user data communications network 103 or the operations administration network 105. The transmitter 1403 sends data via the user data communications network 103 or the operations administration network 105. The live migration unit 1405 performs source live migration processing and destination live migration processing. The table storage unit 1407 stores the migration table 601. The control unit 1409 controls the migration processing of the virtual machine 209. The virtual machine administration unit 1411 stores the virtual machine 209 and the virtual switch 211 in a predetermined region and manages the virtual machine 209 and the virtual switch 211.

The configuration administration unit 1413 manages information related to configuration such as the CPU, memory, and network interfaces of the physical server 101, and statistical information such as the CPU load, memory usage status, and network usage status. The configuration information storage unit 1415 stores information related to configuration such as the CPU, memory, and network interfaces of the physical server 101, and statistical information such as the CPU load, memory usage status, and network usage status. The processing of the configuration administration unit 1413 which uses the configuration information storage unit 1415 corresponds to that of the related art, and the description thereof is omitted.

The control unit 1409 includes a sending unit 1421, a receiving unit 1423, an analyzing unit 1425, a recovery unit 1427, and a transfer unit 1429. The sending unit 1421 performs processing for sending data regarding the virtual machine 209. The receiving unit 1423 performs processing for receiving the data regarding the virtual machine 209. The analyzing unit 1425 analyzes the ARP packet which contains the migration table 601. The recovery unit 1427 performs recovery process when an error occurs during the live migration processing. The transfer unit 1429 transfers the ARP packet via the user data communications network 103.

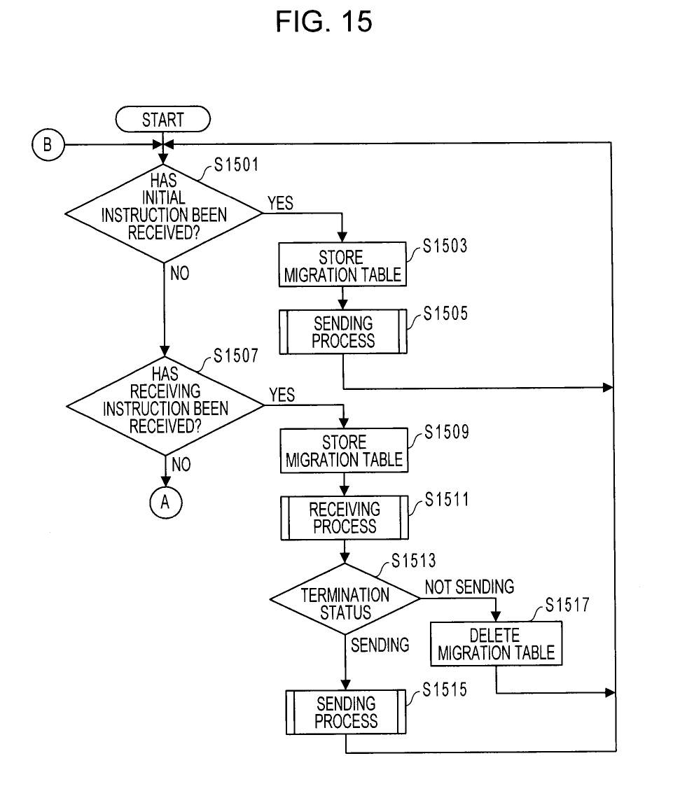

FIG. 15 is a diagram illustrating an example of an operational flowchart for a hypervisor including a virtual machine, according to an embodiment, where a hypervisor 207 includes a virtual machine 209. The control unit 1409 determines whether or not an initial instruction has been received via the receiver 1401 (S1501). The control unit 1409 stores the migration table 601 included in the received initial instruction in the table storage unit 1407 when it is determined that the initial instruction has been received via the receiver 1401 (S1503). Then, the sending unit 1421 performs sending process (S1505).

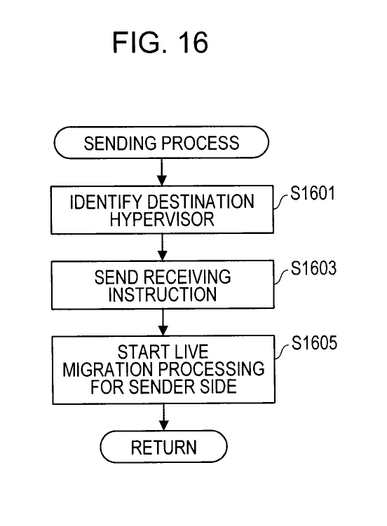

FIG. 16 is a diagram illustrating an example of an operational flowchart for sending process, according to an embodiment. The sending unit 1421 identifies the receiver hypervisor 207 (S1601). For example, the sending unit 1421 identifies a record related to the live migration to be executed on the basis of the execution priority according to the migration table 601, and reads the IP address for the receiver hypervisor from the identified record. At this time, the sending unit 1421 performs a configuration check to determine whether or not the receiver hypervisor 207 is configured to receive the virtual machine 209 to be migrated.

The sending unit 1421 sends the receiving instruction to the receiver hypervisor 207 (S1603). As previously described, the receiving instruction includes the migration table 601 and the retry limit count.

The sending unit 1421 starts the live migration processing for the source side, which is performed by the live migration unit 1405 (S1605). The sending unit 1421 returns to the processing of S1501 illustrated in FIG. 15 without waiting for the completion of the live migration processing for the source side. The processing of S1501 through S1505 corresponds to the operations of the hypervisor 207a regarding S503 through S509 in the operational sequence illustrated in FIG. 5.

Returning to the description of the operational flowchart illustrated in FIG. 15, the control unit 1409 determines whether or not the receiving instruction has been received via the receiver 1401 when it is determined that the initial instruction has not been received via the receiver 1401 at S1501 (S1507). The control unit 1409 stores the migration table 601 in the table storage unit 1407 when it is determined that the receiving instruction has been received via the receiver 1401 (S1509). Then, the receiving unit 1423 performs the receiving process (S1511).

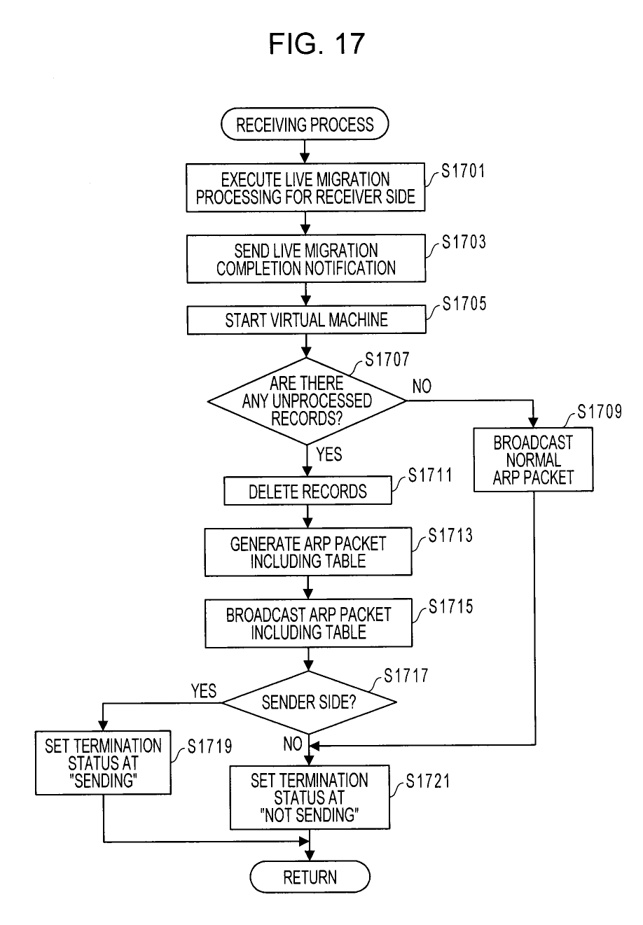

FIG. 17 is a diagram illustrating an example of an operational flowchart for a receiving process, according to an embodiment. The receiving unit 1423 executes live migration processing for the receiver side (S1701). The received virtual machine 209 is stored in a predetermined region of the virtual machine administration unit 1411 during the live migration processing for the receiver side.

The live migration processing terminates at a timing when the synchronization of a storage region for a virtual machine 209 for the sender side and a storage region for a virtual machine 209 on the receiver side completes. The transmitter 1403 waits for completion of the live migration processing for the receiver side and then transmits a live migration completion notification to the hypervisor 207 on the sender side (S1703). Then, the receiving unit 1423 starts the virtual machine 209 stored in the predetermined region (S1705).

The receiving unit 1423 determines whether or not there are any unprocessed records in the migration table 601 (S1707). When it is determined that there are no unprocessed records left in the migration table 601, the transmitter 1403 broadcasts a normal ARP packet (S1709). The processing to broadcast a normal ARP packet may be performed based on the related art, and the description thereof is omitted. The operation to broadcast a normal ARP packet is not illustrated in the previously described operational sequence.

The receiving unit 1423 deletes a record regarding the live migration processing that has completed when it is determined that there are unprocessed records left in the migration table 601 (S1711). The receiving unit 1423 generates an ARP packet which contains the migration table 601 (S1713). For example, the receiving unit 1423 generates a normal ARP packet, and writes data that includes the authentication information 901, the retry limit count 903, and the migration table 905 illustrated in FIG. 9, into the data portion 813 illustrated in FIG. 8. The transfer unit 1429 broadcasts the generated ARP packet containing the migration table 601, via the transmitter 1403 (S1715).

The receiving unit 1423 determines whether or not the receiving unit 1423 is included in the hypervisor 207 that is on the sender side of the live migration to be executed next (S1717). For example, the receiving unit 1423 identifies a record related to the live migration to be executed next, on the basis of the execution priority according to the migration table 601, and then determines whether or not a virtual machine identified by the virtual machine ID included in the record is running on the hypervisor 207 including the receiving unit 1423. The receiving unit 1423 determines that a hypervisor 207 including the receiving unit 1423 is a sender hypervisor 207 that is on the sender side of the live migration to be executed next when it is determined that the virtual machine 209 identified by the virtual machine ID is running on the hypervisor 207. Conversely, the receiving unit 1423 determines that a hypervisor 207 including the receiving unit 1423 is not a sender hypervisor 207 that is on the sender side of the live migration to be executed next when it is determined that the virtual machine 209 identified by the virtual ID is not running on the hypervisor 207. The receiving unit 1423 may also determine that a hypervisor 207 including the receiving unit 1423 is a sender hypervisor 207 on the basis of the sender hypervisor IP address included in the identified record.

This determination is made for each migration instruction when there are multiple live migration instructions with the same execution priority. When it is determined, for at least one of the multiple live migration instructions, that the virtual machine 209 identified by the virtual machine ID is running on the hypervisor including the receiving unit 1423, the receiving unit 1423 determines whether or not the hypervisor including the receiving unit 1423 is a sender hypervisor 207 of the live migration to be executed next. When it is determined, for none of the multiple live migration instructions, that the virtual machine 209 identified by the virtual machine ID is running on the hypervisor including the receiving unit 1423, the receiving unit 1423 determines that the hypervisor including the receiving unit 1423 is not a sender hypervisor 207 of the live migration to be executed next.

The receiving unit 1423 sets the termination status at “sending” when it is determined that a hypervisor 207 including the receiving unit 1423 is the sender hypervisor 207 of the live migration to be processed next (S1719). The receiving unit 1423 sets the termination status at “not sending” when it is determined that a hypervisor 207 including the receiving unit 1423 is not the sender hypervisor 207 of the live migration to be processed next (S1721). Next, the processing returns to S1513 illustrated in FIG. 15.

Returning to description of the operational flowchart illustrated in FIG. 15, the control unit 1409 determines whether the termination status regarding the receiving process (S1511) is “sending” or “not sending” (S1513).

The sending unit 1421 performs the sending process similar to that previously described when the termination status regarding the receiving process (S1511) is determined to be “sending” (S1515). The processing then returns to S1501. The processing of S1507 through S1515 corresponds to the operation of the hypervisor 207b regarding S505, S509, S511, S515, S521, S523, and S525 in the operational sequence illustrated in FIG. 5.

Conversely, the control unit 1409 deletes the migration table 601 stored in the table storage unit 1407 when the termination status regarding the receiving process (S1511) is determined to be “not sending” (S1517). The processing then returns to S1501. The processing of S1507 through S1513, and S1517 corresponds to the operation of the hypervisor 207d regarding S521, S525, 51001, and S1005 in the operational sequence illustrated in FIG. 5 and FIG. 10.

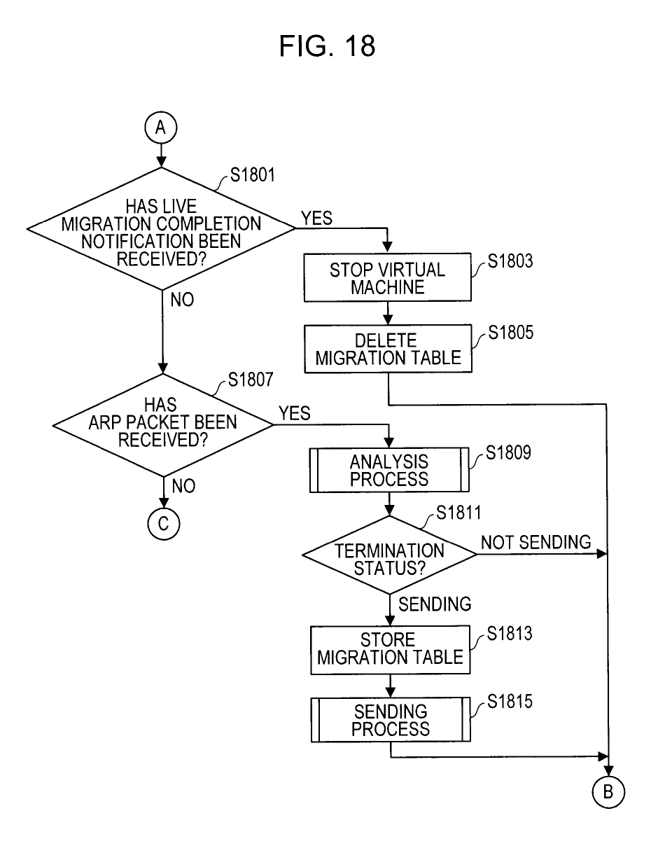

The processing proceeds to S1801 in FIG. 18 via a terminal A when it is determined that the receiving instruction has not been received via the receiver 1401 at S1507 illustrated in FIG. 15.

FIG. 18 is a diagram illustrating an example of an operational flowchart for a hypervisor including a virtual machine, according to an embodiment, where the continuation of the operational flowchart of FIG. 15 is illustrated. The control unit 1409 determines whether or not the live migration completion notification has been received via the receiver 1401 (S1801). When it is determined that the live migration completion notification has been received via the receiver 1401, the control unit 1409 stops the virtual machine 209 of which the migration has completed (S1803). The control unit 1409 deletes the migration table 601 stored in the table storage unit 1407 (S1805). Then, the processing returns to S1501 illustrated in FIG. 15 via a terminal B. The processing of S1801 through S1805 corresponds to the operation of the hypervisor 207a regarding S513 in the operational sequence illustrated in FIG. 5 and the operation of the hypervisor 207b regarding S1003 in the operational sequence illustrated in FIG. 10.

According to the present embodiment, the virtual machine is stopped by the live migration completion notification in the example illustrated, but the control unit 1409 may be configured to stop the virtual machine 209 by determining the completion of the live migration without using the live migration completion notification.

Conversely, when it is determined that the live migration completion notification has not been received via the receiver 1401 (NO in S1801), the control unit 1409 determines whether or not the ARP packet containing the migration table 601 has been received via the receiver 1401 (S1807). When it is determined that the ARP packet containing the migration table 601 has been received (YES in S1807), the analyzing unit 1425 performs the analysis process (S1809).

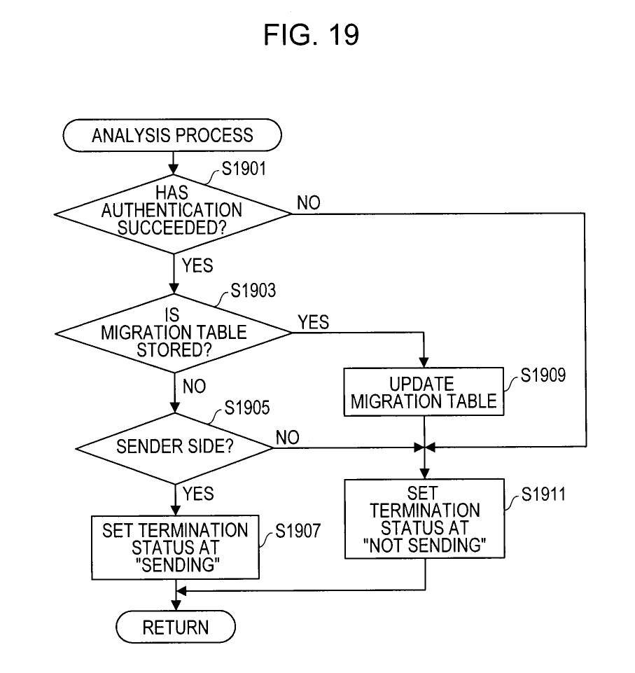

FIG. 19 is a diagram illustrating an example of an operational flowchart for an analysis process, according to an embodiment. The analyzing unit 1425 first performs authentication processing (S1901). For example, the analyzing unit 1425 extracts the authentication information 901 included in the data portion 813 from the ARP packet 801, determines whether or not the ARP packet is authorized on the basis of the authentication information 901, and determines that an authentication has succeeded when the ARP packet is determined to be authorized. The analyzing unit 1425 determines that the authentication has failed when the ARP packet is determined not to be authorized. The analyzing unit 1425 determines that the ARP packet is authorized, for example, when the authentication information 901 matches a predetermined secret code, and determines that the ARP packet is not authorized when the authentication information 901 does not match the predetermined secret code. The secret code may be an ID and password shared between the administration unit 401 and the hypervisor 207, for example.

When it is determined that the authentication has failed (NO in S1901), the analyzing unit 1425 sets the termination status at “not sending” (S1911). Such processing may avoid receiving of unauthorized virtual machines.

Conversely, when it is determined that the authentication has succeeded (YES in S1901), the analyzing unit 1425 determines whether or not the migration table 601 is stored in the table storage unit 1407 (S1903). When it is determined that the migration table 601 is not stored in the table storage unit 1407 (NO in S1903), the analyzing unit 1425 determines whether or not the analyzing unit 1425 is included in the sender hypervisor 207 of the live migration to be executed next (S1905). For example, the analyzing unit 1425 identifies a record related to the live migration to be executed next on the basis of the execution priority set to the record in the migration table 601, and determines whether or not the hypervisor including the analyzing unit 1425 is running the virtual machine 209 identified by the virtual machine ID included in the identified record. The analyzing unit 1425 determines that the hypervisor including the analyzing unit 1425 is the sender hypervisor 207 of the live migration to be executed next when it is determined that the virtual machine 209 identified by the virtual machine ID is running on the hypervisor including the analyzing unit 1425. Conversely, the analyzing unit 1425 determines that the hypervisor including the analyzing unit 1425 is not the sender hypervisor 207 of the live migration to be executed next when the virtual machine 209 identified by the virtual machine ID is not running on this hypervisor. The analyzing unit 1425 may also be configured to determine whether or not this hypervisor is the sender hypervisor 207 on the basis of the sender hypervisor IP address included in the identified record.

When there exist multiple live migration instructions with the same execution priority, the determination is made for each migration instruction. When it is determined, for at least one of the multiple live migration instructions, that the virtual machine 209 identified by the virtual machine ID is running on this hypervisor, the analyzing unit 1425 determines whether this hypervisor is the sender hypervisor 207 for the live migration to be executed next. When it is determined, for none of the multiple live migration instructions, that the virtual machine 209 identified by the virtual machine ID is running on this hypervisor, the analyzing unit 1425 determines that this hypervisor is not the sender hypervisor 207 for the live migration to be executed next.

The analyzing unit 1425 sets the termination status at “sending” when it is determined that this hypervisor is the sender hypervisor 207 for the live migration to be executed next (S1907).

The analyzing unit 1425 sets the termination status at “not sending” when it is determined that this hypervisor is not the sender hypervisor 207 for the live migration to be executed next (S1911).

When it is determined that the migration table 601 is stored in the table storage unit 1407 (YES in S1903), the analyzing unit 1425 updates the migration table 601 (S1909). For example, the analyzing unit 1425 overwrites the migration table 601 stored in the table storage unit 1407 with the migration table 905 extracted from the data portion 813 in the ARP packet 801. Then, the analyzing unit 1425 sets the termination status at “not sending” (S1911).

The analysis process is complete after the termination status is set at either “sending” or “not sending”, and then the processing proceeds to S1811 illustrated in FIG. 18.

In the case of executing live migrations in serial, the migration table 601 is not being stored in the table storage unit 1407 at the timing when the ARP packet containing the migration table 601 is received. A state in which the migration table 601 is being stored in the table storage unit 1407 at the timing when the ARP packet containing the migration table 601 is received occurs during the execution of live migrations in parallel. Therefore, the update of the migration table at S1909 occurs during the execution of live migrations in parallel.

Hereafter, transfer of the migration table 601 regarding the execution of live migrations in parallel will be described.

In the operational sequence illustrated in FIG. 10, an ARP packet containing the migration table 601c illustrated in FIG. 11 is broadcast at S1005. The hypervisors 207a through 207c perform the analysis processes. As a result, the hypervisor 207a determines that the hypervisor 207a is a sender hypervisor 207 on the basis of the first record, sends a receiving instruction to the hypervisor 207b as illustrated in FIG. 10 (S1011), and further sends the data of the virtual machine 209b (virtual machine ID: 1010121) to the hypervisor 207b (S1015) by way of the source live migration processing (S1013). In response, the hypervisor 207b performs live migration processing on the receiver side.

At the same time, the hypervisor 207c determines that the hypervisor 207c is a sender hypervisor on the basis of the second record in the migration table 601c illustrated in FIG. 11. Though not illustrated in FIG. 10, the hypervisor 207c transmits a receiving instruction to the hypervisor 207d, and transmits data of the virtual machine 209d (virtual machine ID: 1012001) to the hypervisor 207d by performing the live migration processing on the sender side. In response, the hypervisor 207d performs live migration processing on the receiver side.

A migration table 601d regarding the hypervisor 207b at this time is illustrated in FIG. 20. The migration table 601d is similar to the migration table 601c illustrated in FIG. 11.

Conversely, a migration table 601h regarding the hypervisor 207d is illustrated in FIG. 21. The migration table 601h is similar to the migration table 601c illustrated in FIG. 11.

That is, at the timing when the live migration processing on the receiver side is started in parallel for the hypervisor 207b and the hypervisor 207d, both the hypervisors 207b and 207d store the same migration table 601.

In the case, it is assumed that the live migration processing on the receiver side for the hypervisor 207d is completed first. At this timing, the hypervisor 207d deletes the first record related to the live migration already executed. As a result, the migration table is updated as illustrated in a migration table 601i of FIG. 21.

Meanwhile, as the live migration processing on the receiver side for the hypervisor 207b is still in progress, the migration table at this timing is similar to the migration table 601e as illustrated in FIG. 20, that is, there are no changes in the migration table from that (the migration table 601d) at the timing when the live migration processing was started.

In theory, if the hypervisor 207b finishes the live migration processing on the receiver side and deletes the second record related to the live migration already executed, from the migration table in the state as represented by the migration table 601e, the first record regarding the live migration processing that is on the receiver side and has already been finished at the hypervisor 207d still remains, which causes an error.

According to the embodiment, the hypervisor 207d which has first completed the receiving process broadcasts an ARP packet which contains the migration table 601i, and the hypervisor 207b overwrites the migration table thereof with the migration table 601i included in the received ARP packet. As a result, the hypervisor 207b holds a migration table 601f as illustrated in FIG. 20. In this way, the correct state of the migration table 601 is maintained. The hypervisor 207d then discards the migration table 601i held therein.

Afterwards, the hypervisor 207b finishes the migration processing for the receiver side, deletes the first record from the migration table 601f related to the live migration already executed, and updates the migration table thereof to the migration table 601g as illustrated in FIG. 20.

Then, the hypervisor 207b broadcasts the ARP packet which contains the migration table 601g. Afterwards, the migration table 601g is discarded.

For example, in a state in which the migration table 601e illustrated in FIG. 20 is held, the analyzing unit 1425 in the hypervisor 207b determines that the migration table 601 is stored at S1903 as illustrated in FIG. 19. Then, transition to the migration table 601f illustrated in FIG. 20 is performed by updating the migration table at S1909 as illustrated in FIG. 19.

This concludes the description of the transition of the migration table 601 when executing live migrations in parallel.

Returning to description of the operational flowchart illustrated in FIG. 18, the control unit 1409 determines whether the termination status from the analysis process (S1809) is set at “sending” or “not sending” (S1811). When the termination status from the analysis process is determined to be set at “not sending”, the processing proceeds to 1501 illustrated in FIG. 15 via the terminal B. The operations from S1807 through S1811, in which it is determined that the termination status is set at “not sending”, correspond to the operation S517 of the hypervisor 207a in the operational sequence illustrated in FIG. 5, the operation 5519 of the hypervisor 207d in FIG. 5, and the operation S1009 of the hypervisor 207b in the operational sequence illustrated in FIG. 10.

When the termination status from the analysis process (S1809) is determined to be set at “sending”, the control unit 1409 stores the migration table 601 extracted from the ARP packet containing the migration table 601 in the table storage unit 1407 (S1813). The sending unit 1421 performs the previously described sending process (S1815). The processing then returns to S1501 illustrated in FIG. 15. The operations from S1807 through S1815 correspond to the operation S1007 of the hypervisor 207a in the operational sequence illustrated in FIG. 10.

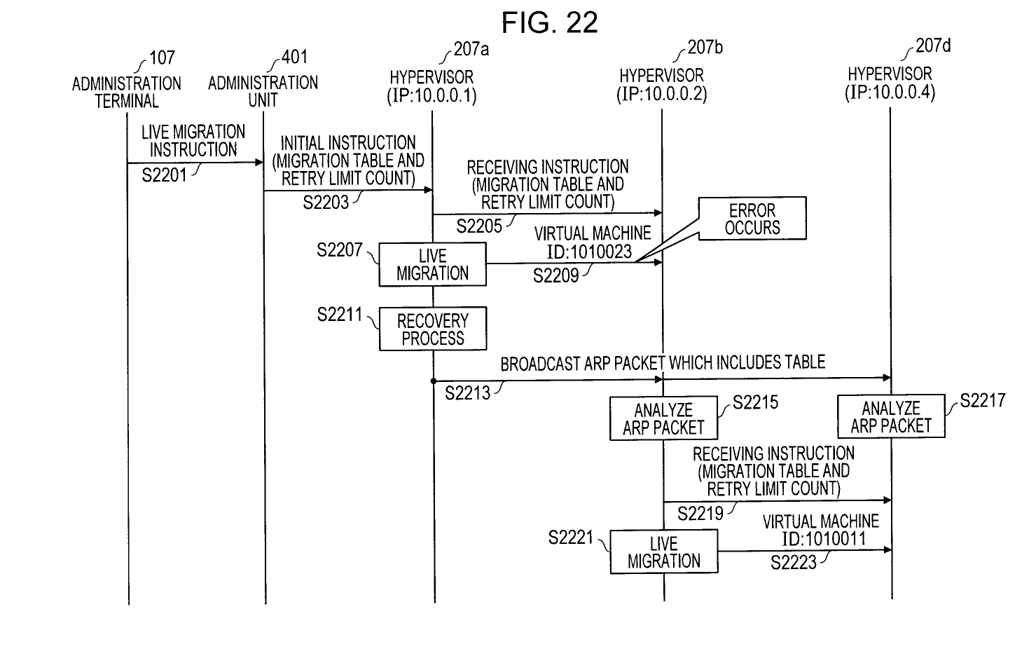

Next, the recovery process that is executed when an error occurs during the live migration will be described with reference to FIGS. 22 through 24. Errors may occur, for example, when there is temporary congestion on the operations administration network 105.

FIG. 22 is a diagram illustrating an example of an operational sequence when an error has occurred, according to an embodiment. In a manner similar to FIG. 5, the administration unit 401 receives the live migration instruction from the management terminal 107 (S2201). The live migration instruction includes the migration table 601 and the retry limit count. The retry limit count is the number of retries that may be attempted when an error occurs during the live migration.

In a manner similar to the operational sequence illustrated in FIG. 5, a receiving instruction includes the migration table 601a for the initial stage illustrated in FIG. 6. Since no live migrations have yet been executed at the initial stage, an error count for any one of the records is zero.

In a manner similar to the operational sequence illustrated in FIG. 5, the administration unit 401 identifies the hypervisor 207a on the sender side, based on the first record, which has an execution priority of one, and then the administration unit 401 sends the initial instruction to the hypervisor 207a (S2203). The initial instruction includes the migration table 601a and the retry limit count. The hypervisor 207a which has received the initial instruction temporarily stores the migration table 601a.

In a manner similar to the operational sequence illustrated in FIG. 5, the hypervisor 207 sends the receiving instruction to the hypervisor 207b (S2205). Then, the hypervisor 207a performs the live migration (S2207). For example, the hypervisor 207a sends data of the virtual machine 209a (virtual machine ID: 1010023) to the hypervisor 207b (S2209). In the case, it is assumed that an error occurs during this live migration.

The hypervisor 207a, which has detected a live migration failure, performs the recovery process (S2211). For example, the hypervisor 207a increments an error count for a record, in the migration table 601a, related to the failed live migration. In this example, the error count is set at one, and the execution priority of the record related to the failed live migration is lowered.

The hypervisor 207a broadcasts an ARP packet which contains the updated migration table 601 (S2213).

Hereafter, description will proceed to the normal operation based on the second record in the migration table 601a illustrated in FIG. 6. For example, the hypervisor 207b performs the analysis of the ARP packet (S2215), and the hypervisor 207d also performs the analysis of the ARP packet (S2217). The hypervisor 207b determines that the hypervisor 207b is a sender hypervisor 207, and sends a receiving instruction to the hypervisor 207d (S2219). Then, the hypervisor 207b performs the live migration (S2221). That is, the hypervisor 207b transmits data of the virtual machine 209c (virtual machine ID: 1010011) to the hypervisor 207d (S2223).

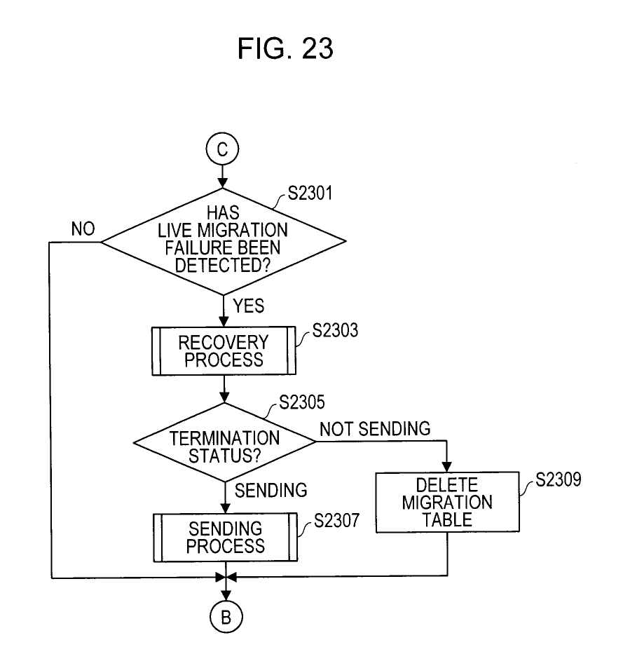

Next, the recovery process will be described. When it is determined that the ARP packet containing the migration table 601 is not received via the receiver 1401 in S1807 of the operational flowchart illustrated in FIG. 18, the processing proceeds to S2301 of FIG. 23 via a terminal C. FIG. 23 is a diagram illustrating the continuance of the operational flowchart of FIG. 18. The control unit 1409 determines whether or not a live migration failure has been detected by the live migration unit 1405 (S2301). When it is determined that a live migration failure has not been detected by the live migration unit 1405, the processing returns to S1501 of FIG. 15 via the terminal B.

When it is determined that a live migration failure has been detected by the live migration unit 1405, the recovery unit 1427 performs the recovery process (S2303).

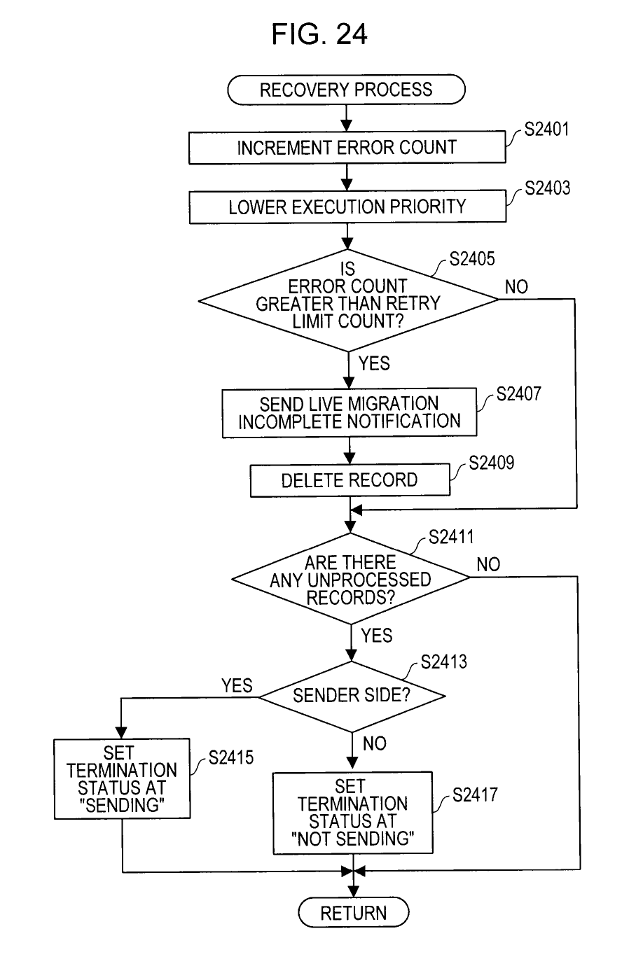

FIG. 24 is a diagram illustrating an example of an operational flowchart for a recovery process, according to an embodiment. The recovery unit 1427 identifies a record related to the failed live migration from the migration table 601, and increments an error count for the relevant record (S2401). The recovery unit 1427 lowers the execution priority of the relevant record (S2403). For example, the last execution priority is identified, and then the execution priority for the record is set at an execution priority next to the last execution priority. The recovery unit 1427 determines whether or not the error count is greater than the retry limit count (S2405). The processing proceeds to S2411 when the error count is determined to be the same or less than the retry limit count (S2405). Conversely, the transmitter 1403 sends the live migration incomplete notification to the administration unit 401 when the error count is determined to be greater than the retry limit count (S2407). The live migration incomplete notification includes the virtual machine ID, the sender hypervisor IP address, and the receiver hypervisor IP address, for example. The recovery unit 1427 deletes the record (S2409). The recovery unit 1427 determines whether or not there are any unprocessed records in the migration table 601 (S2411). When it is determined that there are no unprocessed records left in the migration table 601, the recovery unit 1427 finishes the recovery process and the processing returns to the processing that has called the recovery process.

When it is determined that there are unprocessed records left in the migration table 601 (YES in S2411), the recovery unit 1427 determines whether or not the hypervisor including the recovery unit 1427 is a sender hypervisor 207 for the live migration to be executed next (S2413). For example, the recovery unit 1427 identifies a record related to the live migration to be executed next, on the basis of the execution priority in the migration table 601, and then determines whether or not a virtual machine identified by the virtual machine ID is running on the hypervisor including the recovery unit 1427. The recovery unit 1427 determines that the hypervisor including the recovery unit 1427 is a sender hypervisor 207 for the live migration to be executed next when the virtual machine identified by the virtual machine ID is determined to be running on this hypervisor. Conversely, the recovery unit 1427 determines that this hypervisor is not a sender hypervisor 207 for the live migration to be executed next when the virtual machine identified by the virtual machine ID is not determined to be running on this hypervisor. The recovery unit 1427 may also determine whether or not this hypervisor is a sender hypervisor 207 on the basis of the source IP address included in the relevant record.

The recovery unit 1427 sets the termination status at “sending” (S2415) when this hypervisor is determined to be a sender hypervisor 207 for the live migration to be executed next, and finished the recovery process. The recovery unit 1427 sets the termination status at “not sending” (S2417) when this hypervisor is not determined to be a sender hypervisor 207 for the live migration to be executed next, and finishes the recovery process. The processing returns to S2305 illustrated in FIG. 23 after the recovery process finishes.

Returning to the operational flowchart of FIG. 23, the control unit 1409 determines whether the termination status from the recovery process (S2303) is set at “sending” or “not sending” (S2305). When the termination status from the recovery process (S2303) is determined to be set at “sending”, the sending unit 1421 performs the sending process (S2307), and the processing returns to S1501 of FIG. 15 via the terminal B.

When the termination status from the recovery process (S2303) is determined to be set at “not sending”, the control unit 1409 deletes the migration table 601 stored in the table storage unit 1407 (S2309), and the processing returns to S1501 of FIG. 15 via the terminal B.

Lastly, the advantages of setting live migrations to be executed in serial and the advantages of setting live migrations to be executed in parallel will be described.

When the live migration instruction represented by the first record in the migration table 601a of FIG. 6 is executed, for example, the data of the virtual machine 209a is sent from the hypervisor 207a to the hypervisor 207b. At this time, the data of the virtual machine 209a passes through the physical switch 301a. When the live migration instruction represented by the second record, the data of the virtual machine 209c is sent from the hypervisor 207b to the hypervisor 207d. At this time, the data of the virtual machine 209c passes through the physical switch 301a, the physical switch 301c, and the physical switch 301b. When the above mentioned two live migrations are performed in parallel, the bandwidth for the transfer path between the physical switch 301a and the physical server 101b is shared by the two live migrations and time needed for data transfer becomes longer in comparison with executing the two live migrations in series.

When a time period to complete the data transfer becomes longer like this, possibility that the data of the virtual machine 209 is updated during the time period increases. When the data of the virtual machine 209 is updated, processing for retransferring difference data generated during the time period is executed, which further delays the process. Therefore, it is preferable to perform multiple live migrations in serial when the multiple live migrations share the bandwidth for transfer paths thereof.

As another example, when the live migration instruction represented by the third record in the migration table 601a of FIG. 6 is executed, the data of the virtual machine 209b is sent from the hypervisor 207a to the hypervisor 207b. At this time, the data of the virtual machine 209b passes through the physical switch 301a. Also, when the live migration instruction represented by the fourth record is executed, the data of the virtual machine 209d is sent from the hypervisor 207c to the hypervisor 207d. At this time, the data of the virtual machine 209d passes through the physical switch 301b. In the case, since the transfer paths used when executing these two live migrations in parallel do not share bandwidth, executing the two live migrations in parallel does not cause time delay.

Therefore, it is preferable to execute multiple live migrations in parallel when the multiple live migrations do not share the bandwidth for the transfer paths thereof.

In this way, the overall processing time may be reduced by selecting one of a live migration to be executed in serial and a live migration to be executed in parallel, depending on a transfer path used to transfer the data of the virtual machine.

According to the embodiment, for example, it is unnecessary for the administration unit 401 to instruct a hypervisor to execute multiple live migrations intensively. In this way, the processing related to the control of multiple migrations may be distributed by causing the physical server 101 on the receiver side to process a next migration instruction, thereby enabling the reduction of the processing load regarding the physical server managing multiple live migrations.

According to the embodiment, since a physical server 101 that has received the migration table via the broadcast determines whether or not the physical server 101 is to be on the sender side, it is unnecessary for the physical server 101 that sends the migration table to identify a physical server 101 that is to be on the sender side.

When executing a live migration, the migration table is sent from the source physical server 101 to the destination physical server 101, and the destination physical server 101 which has completed the live migration may execute multiple live migrations consecutively, without involving the administration unit 401, by sequentially repeating the broadcasting of the migration table.

The migration table is transferred as part of an ARP packet, thereby simplifying control on the migration of the virtual machine.

Further, authentication information may be included in the ARP packet, which is useful in filtering fake migration information.

In the above described example, the migration table is transferred with being included in an ARP packet. However, the migration table may be transferred separately from the ARP packet. The migration table may be broadcast by the transfer unit 1429 during the processing represented by S1715 in FIG. 17, for example. The receipt of the migration table may be determined at S1807 in FIG. 18, and the analysis process represented by S1809 may be performed using this received migration table. Authentication information may also be added to the migration table in this case.

In the above described example, the migration table is transferred to the next sender hypervisor 207 by broadcasting the ARP packet containing the migration table. However, the migration table may be transferred to the next sender hypervisor 207 by unicast. In this case, the transfer unit 1429 may execute processing to send a unicast instead of the processing for the broadcast, which is performed by the transfer unit 1429 and represented by S1715 in FIG. 17. The sender hypervisor IP address included in a live migration instruction corresponding to the next execution priority would be identified during the unicast processing, and the migration table is sent to the identified sender hypervisor IP address. The analysis process represented by S1809 may be omitted when it is determined that the migration table was received at S1807 in FIG. 18. When the analysis process is omitted, the processing that is to be performed when the termination status is determined to be set at “sending” in S1811 may be performed. That is, the processing to store the migration table as represented by S1813 and the sending process represented by S1815 may be performed.

Though this concludes the description of the embodiments, the embodiments ate not limited to this. For example, there may be cases in which the functional block configuration previously described does not match an actual program module configuration.

The configuration of each storage region as above described is only one example, and this does not have to be interpreted as the only viable configuration. Also regarding the process flows, the order of each process may be changed so long as the processing result remains the same. These processes may also be executed in parallel.

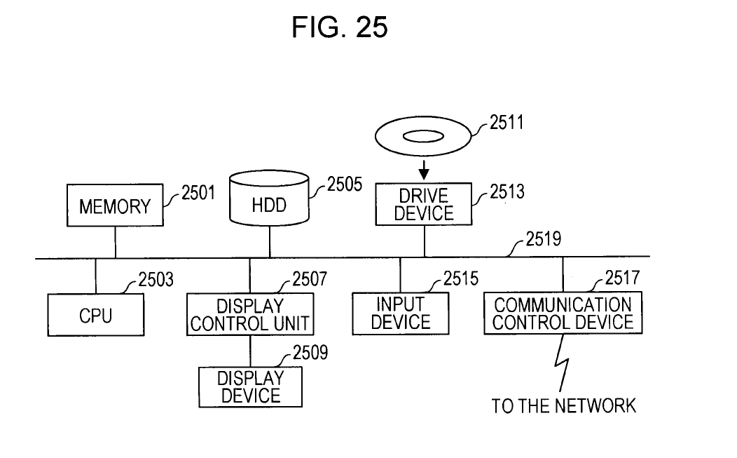

The physical server 101 above described is a computer device, and as illustrated in FIG. 25, a memory 2501, CPU 2503, hard disk drive (HDD) 2505, a display control unit 2507 connected to a display device 2509, a drive device 2513 for a removable disk drive 2511, an input device 2515, and a communications control unit 2517 for connecting to networks are connected by a bus 2519. The operating system (OS) and application programs for implementing the embodiments are stored in the HDD 2505, and are read from the HDD 2505 into the memory 2501 when executed by the CPU 2503. The CPU 2503 controls the display control unit 2507, the communications control unit 2517, and the drive device 2513 in response to the processing of the application program to perform predetermined operations. The data used during the processing is mainly stored in the memory 2501, but may also be stored in the HDD 2505. According to the embodiment, the application programs for implementing the previously described processing are stored in and distributed by a computer readable removable disk 2511, and are then installed onto the HDD 2505 from the drive device 2513. The programs may also be installed onto the HDD 2505 via a network such as the Internet and the communications control unit 2517. Such a computer device implements the above described various functions by the organic cooperation of the hardware, such as the above described CPU 2503 and the memory 2501, and programs, such as the OS and the application programs.

The following serves as an overview of the above described embodiments.

The method for migrating virtual machines according to the embodiment is performed by a first physical device running a first virtual machine. The method includes: receiving first migration information including a first migration instruction regarding the first virtual machine and a second migration instruction regarding a second virtual machine; receiving data for the first virtual machine; and transferring second migration information including the second migration instruction to a second physical device running the second virtual machine.

In this way, the first physical device which accepts the first virtual machine regarding the first migration instruction transfers the second migration information including the second migration instruction to a second physical device running the second virtual machine. Therefore, multiple live migrations do not necessarily have to be centrally instructed by an administration unit, for example. The processing related to the control of multiple migrations may be distributed by causing a physical device receiving the next migration instruction to process a next migration instruction, thereby enabling reduction of the processing load regarding the physical server managing multiple live migrations.

The method for migrating virtual machines may include determining, upon receiving third migration information that has been broadcast and includes a third migration instruction, whether a third virtual machine regarding the third migration instruction is running on the first physical device. Further, the method for migrating virtual machines may include sending, when it is determined that the third virtual machine is running on the first physical device, data for the third virtual machine to the second physical device to which the third virtual machine is to be migrated.

In this way, a first physical device which has received the third migration information including the third migration instruction determines whether the first physical device is on the sender side for the third virtual machine regarding the third migration instruction. Therefore, it is unnecessary for the sender of the third migration information to identify a source physical device on the sender side of the third virtual machine.

The third migration information may include a fourth migration instruction. Further, the method for migrating virtual machines may include sending the third migration information to the second physical device to which the third virtual machine is to be migrated, when it is determined that the first physical device is running the third virtual machine.

In this way, a physical device that is to accept the above mentioned third virtual machine becomes able to transfer the migration information including the fourth migration instruction to a physical device which migrates a virtual machine in accordance with the fourth migration instruction. This allows multiple live migrations to be executed consecutively without involving the administration unit.

The third migration information may include a plurality of migration instructions and an execution priority assigned to each of the plurality of migration instructions where the plurality of migration instructions include the third migration instruction. Further, the method for migrating virtual machines may identify the third migration instruction in accordance with the execution priority of each migration instruction.

In this way, the migration instruction may be identified according to the execution priority, allowing migrations to be executed in order of priority.

The information on the third migration may include a fourth migration instruction having an execution priority equal to that of the third migration instruction. Further, the method for migrating virtual machines may identify the fourth migration instruction together with the third migration instruction, and determine whether the first physical device is running a fourth virtual machine regarding the fourth migration instruction Here, the method for migrating virtual machines may further include sending data for the fourth virtual machine to the second physical device when it is determined that the first physical device is running the fourth virtual machine.

In this way, the determining and sending processes are executed for each of the two migration instructions have the same execution priority, enabling execution of one or both of the migration instructions that are set to be executed in parallel.

The method for migrating virtual machines may broadcast the second migration information via the transferring process.

In this way, the migration information may be passed to all physical devices which are expected to be a next sender of a virtual machine.

The method for migrating virtual machines may include storing the second migration information into an ARP packet during the transferring process.

This allows the second migration information and the ARP advertisement to be combined, thereby simplifying the control regarding the migration of virtual machines.

The method for migrating virtual machines may transfer authentication information for authenticating the second migration information together with the second migration information during the transferring process.

This allows the authentication information to be used for filtering fake migration information.

The processing by the above described method may be implemented by creating programs to be executed by a computer, and, for example, these programs may be stored on a computer-readable storage medium or storage device, such as a floppy disk, CD-ROM, magneto-optical disk, semiconductor memory, and hard disk. The intermediate processing results may be generally stored temporarily in a storage device, such as the main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method for migrating virtual machines, the method being performed by a first apparatus running a first virtual machine, the method comprising:
receiving first migration information including a first migration instruction regarding the first virtual machine and a second migration instruction regarding a second virtual machine;
receiving data for the first virtual machine; and
transferring second migration information including the second migration instruction to a second apparatus running the second virtual machine.

2. The method of claim 1, further comprising:
determining, upon receiving third migration information that has been broadcast and includes a third migration instruction, whether the first apparatus is running a third virtual machine regarding the third migration instruction; and
sending, when it is determined that the first apparatus is running the third virtual machine, data for the third virtual machine to the second apparatus to which the third virtual machine is to be migrated.

3. The method of claim 2, wherein
the third migration information includes a fourth migration instruction; and
when it is determined that the first apparatus is running the third virtual machine, the first apparatus sends the third migration information to the second apparatus to which the third virtual machine is to be migrated.

4. The method of claim 2, wherein
the third migration information includes a plurality of migration instructions and an execution priority assigned to each of the plurality of migration instructions, the plurality of migration instructions including the third migration instruction; and
the determining includes identifying the third migration instruction in accordance with the execution priorities.

5. The method of claim 4, wherein
the third migration information includes a fourth migration instruction whose execution priority is equal to that of the third migration instruction;
the determining includes identifying the fourth migration instruction;
it is determined whether the first apparatus is running a fourth virtual machine regarding the fourth migration instruction; and
the first apparatus sends data for the fourth virtual machine to the second apparatus when it is determined that the first apparatus is running the fourth virtual machine.

6. The method of claim 1, wherein
the transferring includes broadcasting the second migration information.

7. The method of claim 1, wherein
the transferring includes storing the second migration information into an ARP packet.

8. The method of claim 1, wherein
the transferring includes transferring authentication information for authenticating the second migration information together with the second migration information.

9. An apparatus for running a first virtual machine, the apparatus comprising:
a receiver configured to receive first migration information including a first migration instruction regarding a first virtual machine and a second migration instruction regarding a second virtual machine;
a receiving unit configured to receive data for the first virtual machine; and
a transfer unit configured to transfer second migration information including the second migration instruction to another apparatus running the second virtual machine.

10. A computer-readable recording medium stored therein a program for causing a computer running a first virtual machine to execute a process comprising:
receiving first migration information including a first migration instruction regarding the first virtual machine and a second migration instruction regarding a second virtual machine;
receiving data for the first virtual machine; and
transferring second migration information including the second migration instruction to another computer running the second virtual machine.
